(19) United States
(12) Patent Application Publication
(10) Pub. No.: US 2022/0390035 A1
(43) Pub. Date: Dec. 8, 2022

(54) ARRANGEMENT WITH A VALVE

(71) Applicant: VAT Holding AG, Haag (CH)

(72) Inventors: Florian EHRNE, Frümsen (CH); Martin NETZER, Bludenz (AT); Hanspeter FREHNER, Sevelen (CH)

(73) Assignee: VAT Holding AG, Haag (CH)

(21) Appl. No.: 17/769,800

(22) PCT Filed: Sep. 22, 2020
(86) PCT No.: PCT/EP2020/076379

§ 371 Date: Apr. 18, 2022

(30) Foreign Application Priority Data
Oct. 18, 2019 (DE) 10 2019 128 228.4

(51) Int. Cl. F16K 43/00; F16K 3/12; F16K 3/30; F16K 51/02

(52) U.S. Cl. CPC F16K 43/001; F16K 3/12; F16K 3/30; F16K 51/02

(57) ABSTRACT

An arrangement with a valve having a valve housing and a closure member mounted for movement in an interior space of the valve housing between a closed position and an open position by a valve drive. The closure member closes valve housing openings in the closed position and opens them in the open position. The arrangement has an attachment part with an attachment part housing and a push tube, and the push tube is mounted displaceably in the attachment part housing. The attachment part housing and the push tube together enclose a line cavity of the attachment part for conducting a fluid through the attachment part. The attachment part housing is fastened on the outside to the valve housing, and the push tube can be pushed through the interior space of the valve housing when the closure member is in the open position.

### TECHNICAL FIELD

The present invention relates to an arrangement having a valve, in particular a vacuum valve, wherein the valve has a valve housing and a closure member, said closure member being mounted such that it can be moved back and forth in an interior space of the valve housing between a closed position and an open position by a valve drive of the valve, and two mutually aligned valve-housing openings are arranged in the valve housing, wherein the closure member closes off the valve-housing openings in the closed position and opens up the valve-housing openings in the open position.

### BACKGROUND

Valves of the stated type, in particular also in the form of vacuum valves, are known in numerous configurations. In particular in vacuum technology, problems with soiling in the interior space of the valve housing can always occur if correspondingly contaminated or dirty fluids are passed through the valve and thus also through the interior space of the valve housing.

This problem is already recognized in WO 2011/105737 A2, and a visual representation thereof is also given in FIG. 1 of this document. In order to avoid contamination of the interior space of the valve housing, WO 2011/105737 proposes a tubular extension on the closure member which, in the open position of the closure member, ensures that the tube connects the valve-housing openings in such a way that the fluids transported through the open valve cannot enter the rest of the interior space of the valve housing. For this purpose, WO 2011/105737 A2 provides a specific, relatively complicatedly constructed closure member, in the case of which the means for preventing contamination of the interior space of the valve housing are also themselves arranged permanently in the interior space of the valve housing. For this purpose, the valve housing has to be adapted specifically and be of relatively large design.

### SUMMARY

It is an object of the invention to provide an alternative solution for eliminating the stated problem.

For achieving said object, an arrangement is provided having one or more of the features disclosed herein.

It is consequently provided according to the invention that the arrangement has an attachment part, wherein the attachment part has an attachment-part housing and a push tube, and the push tube is mounted displaceably in the attachment-part housing, wherein the attachment-part housing and the push tube together enclose a line cavity of the attachment part for passing of a fluid through the attachment part, and the attachment-part housing is fastened to the outside of the valve housing, and the push tube of the attachment part can be pushed through the interior space of the valve housing when the closure member is in the open position.

By contrast to the above-stated prior art, the means for preventing contamination of the interior space of the valve housing are consequently no longer part of the valve itself, but rather such a means is made in the form of an attachment part. Said attachment part may be fastened fixedly, but also non-destructively detachably, to the valve housing. The push tube, which is mounted displaceably in the attachment-part housing, can be pushed through the interior space of the valve housing such that, by way of the line cavity of the attachment-part housing and of the push tube, contaminated fluids can be passed through the valve housing without being able to enter that region of the interior space of the valve housing which surrounds the push tube. In this way, it can be ensured that, when passing through the valve housing, the fluids flow exclusively through the line cavity of the attachment part and of the push tube, and the remaining part of the interior space of the valve housing, and thus especially also the closure member, cannot thus be contaminated.

Due to the fact that the attachment part is a part which is, at least initially, separate from the valve, an arrangement according to the invention of the attachment part on the valve also makes it possible for any preexisting valves to be retrofitted for the purpose of equipping said valves specifically for operation with dirty or contaminated fluids. According to the invention, the attachment-part housing is fastened to the outside of the valve housing. The attachment-part housing is therefore situated outside the interior space of the valve housing. As already said above, although it is in principle possible for the attachment-part housing to be attached permanently or in a materially bonded manner, for example by welding, soldering or the like, to the valve housing, a non-destructively detachable type of fastening of the attachment-part housing to the valve housing is expediently involved. For example, screw connections, clamping connections or the like may be involved.

The open position of the closure member in which the push tube of the attachment part can be pushed through the interior space of the valve housing is expediently the maximally open position of the closure member. Expediently, in said maximally open position, the closure member completely opens up the valve-housing openings. The valve-housing openings are those openings in the valve housing through which the fluid can flow into the interior space of the valve housing, and can flow out therefrom, when the push tube is not situated there. By virtue of the mutual alignment of the valve-housing openings, said openings are arranged relative to one another in such a way that the push tube can also be pushed through both of them. Arrangements according to the invention may be formed with a large number of valves which are known per se. This wide variety of possibilities applies in particular also to the closure members of the valves. These may be formed very differently according to the shape and size of the valve-housing openings. The closure members may be closure plates or closure disks but also may be needles or other closure members.

Preferred configurations of the invention provide that the push tube of the attachment part can be pushed through the valve-housing openings of the valve housing when the closure member is in the open position. The push tube can then extend through both valve-housing openings simultaneously in the pushed-through end position.

It is particularly preferably provided that, in an end position of the push tube in which it has been pushed through the valve-housing openings of the valve housing, the line cavity of the attachment part is sealed off with respect to the interior space of the valve housing. This particular effectively prevents contaminated fluids transported through the line cavity of the attachment part from being able to enter the rest of the interior space of the valve housing. The degree of the sealing can be adapted to the respective pressure conditions and other conditions to be considered in the case of the respective embodiment. The sealing should at any rate be configured such that no fluid can pass from the line cavity into the interior space of the valve housing. For sealing, sealing rings which are known per se may be provided between the valve housing and the outer surface of the push tube. The push tube may however also be arranged sealingly with a type of snug fit or the like in those regions of the valve housing which surround the valve-housing opening. In terms of the sealing, it is also expedient for the push tube and/or the attachment-part housing to be of circumferentially closed form.

In order for deposition of contaminants to be avoided as effectively as possible, preferred embodiments provide that the arrangement according to the invention has a temperature-control device for controlling the temperature of the push tube and/or of the attachment-part housing. The temperature-control device may be both a heating device and a cooling device, and may also be both. The task of the temperature-control device is to control the temperature of the push tube and/or the attachment-part housing in such a way that, that is to say to bring them to the temperature at which, deposition of contaminants from the fluids passed through is avoided as far as possible or at least reduced.

It is preferably also provided that the push tube, in its or an end position in which it has been pushed through the valve-housing openings of the valve housing, is respectively sealed off with respect to the valve housing in the region of the valve-housing openings.

In order, with the closure member open, for it to be possible to be pushed into the interior space of the valve housing, preferred variants of the invention provide that the push tube, in an or its end position in which it has been pushed through the interior space of the valve housing, preferably through the valve-housing openings of the valve housing, projects beyond the attachment-part housing. In the opposite end position, the push tube may be arranged completely within the attachment-part housing or else project slightly beyond the attachment-part housing.

Preferred variants of the invention provide that the valve housing has for each valve-housing opening in each case one valve-housing flange. Here, it is expedient for the respective valve-housing flange to surround the respective valve-housing opening. The attachment-part housing expediently has a valve-side flange by way of which it can be fastened to the valve housing, preferably to a corresponding valve-housing flange. Furthermore, the attachment-part housing preferably has a line-side flange which can serve for the fitting of the attachment part to a feed and/or discharge line or to another component.

Preferably, it is provided that the attachment-part housing has a valve-side flange for, preferably non-destructively detachable, fitting of the attachment part to the valve housing, preferably to a valve-housing flange of the valve housing, wherein the push tube can be pushed through the valve-housing openings of the valve housing through the valve-side flange. It is also expedient if the attachment-part housing has a line-side flange for, preferably non-destructively detachable, fitting of the attachment part to a feed or discharge line or to another component. In preferred configurations, the attachment part is consequently expediently arranged between the valve housing and the feed or discharge line or one of the feed or discharge lines.

In principle, it is conceivable for the attachment part to be designed in such a way that the push tube can be displaced relative to the attachment-part housing by hand. However, preferred variants of the invention provide that the attachment part has at least one motorized drive device for displacing the push tube relative to the attachment-part housing. Here, the expression motorized drive device comprises all those drive devices known per se in the prior art which are suitable for carrying out the displacement movement without this having to be carried out by hand. The motorized drive devices may for example be pneumatic or hydraulic drives, electrical drives or else other drives which are known per se, in particular linear drives.

Said motorized drive devices may have as many different configurations as different ways of being arranged on the attachment part. It is for example possible that the motorized drive device is arranged in the attachment part outside the line cavity. However, it is also the case that configurations according to the invention in which it is provided that the motorized drive device is arranged in the attachment part within the line cavity can be realized equally well.

In order for the closure member and the push tube not to collide with one another and/or for the push tube to always be pushed sufficiently far into the interior of the valve housing when the closure member is in the open position, preferably in the maximally open position, preferred variants provide that the motorized drive device for displacing the push tube relative to the attachment-part housing and the valve drive are synchronized with one another. Such a synchronization of motorized drive device and valve drive may be realized for example by means of a regulating device which actuates both the valve drive and the motorized drive device of the attachment part in such a way that the push tube is pushed through the interior space of the valve housing when the closure member is in the open position. Mechanical, hydraulic or pneumatic types of coupling of the motorized drive device and the valve drive for synchronization of both drives are of course also conceivable.

The valve of the arrangement according to the invention is expediently a so-called vacuum valve, that is to say a valve which can be used in so-called vacuum technology. Reference is normally made to vacuum technology if operating states with pressures of less than or equal to 0.001 mbar (millibars) or 0.1 pascals are attained. Vacuum valves are valves which are designed for these pressure ranges and/or corresponding pressure differences with respect to the surroundings. Reference may also be generally made to vacuum valves, however, if they are designed for pressures below normal pressure, that is to say below 1 bar.

### BRIEF DESCRIPTION OF THE DRAWINGS

Further features and details of preferred configurations of the invention will be explained below by way of example in the form of embodiment variants according to the invention. In the figures:

FIGS. 1 to 3 show illustrations relating to a first exemplary embodiment of an arrangement according to the invention;

FIGS. 4 to 8 show illustrations relating to a second exemplary embodiment according to the invention of a corresponding arrangement;

FIGS. 9 and 10 show longitudinal sections through a third exemplary embodiment according to the invention of a corresponding arrangement;

FIGS. 11 and 12 show longitudinal sections through a fourth exemplary embodiment according to the invention of a corresponding arrangement;

FIGS. 13 and 14 show longitudinal sections through a fifth exemplary embodiment according to the invention of a corresponding arrangement; and

FIGS. 15 and 16 show longitudinal sections through a sixth exemplary embodiment according to the invention of a corresponding arrangement.

### DETAILED DESCRIPTION

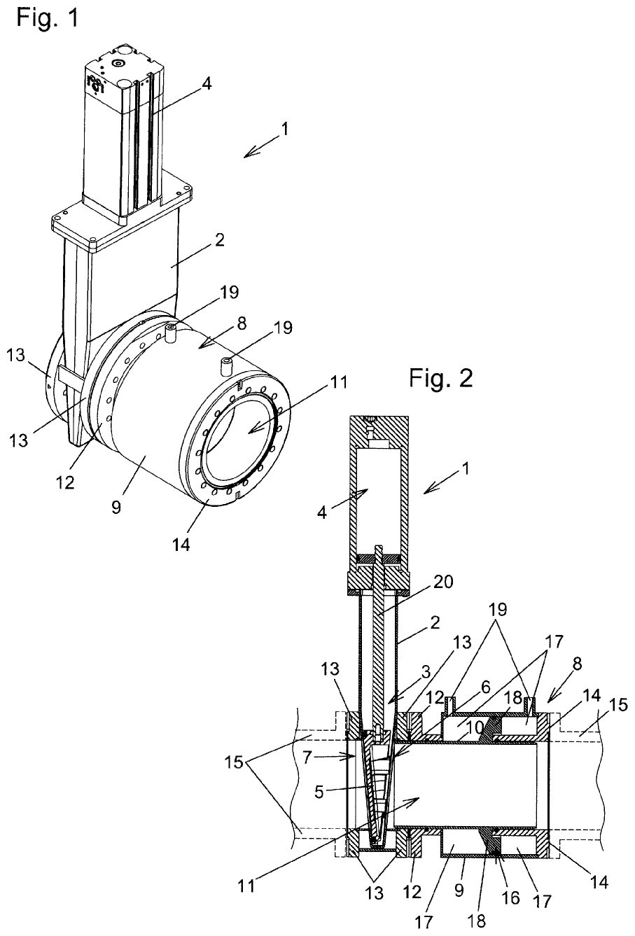

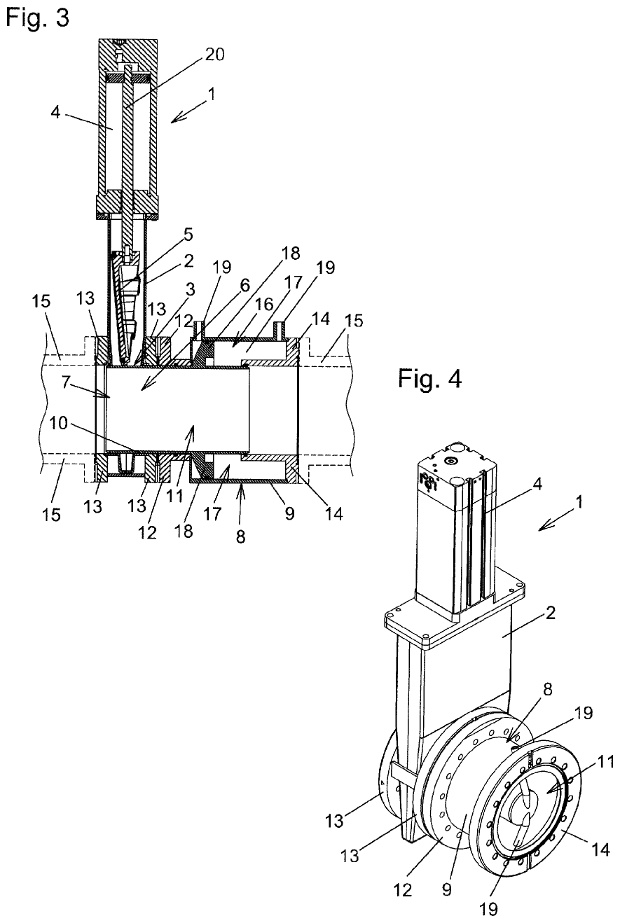

FIG. 1 shows the first exemplary embodiment of the arrangement according to the invention in a perspective illustration. FIGS. 2 and 3 each show a longitudinal section through the arrangement according to the invention. FIGS. 2 and 3 also illustrate, by way of dashed lines, the feed or discharge lines 15 through which the respective fluid flows toward the arrangement according to the invention and also flows away from the latter again. One of said feed or discharge lines 15 is arranged on the line-side flange 14 of the attachment-part housing 9. The other feed or discharge line 15 is arranged on that valve-housing flange 13 of the valve housing 2 which faces away from the attachment part 8. In the longitudinal section as per FIG. 2, the closure member 5 is in the closed position, in which it closes off the valve-housing openings 6 and 7 in the valve housing 2. In the longitudinal section as per FIG. 3, the closure member 5 is in the open position or maximally open position, in which, in this exemplary embodiment, it completely opens up the valve-housing openings 6 and 7.

The valve 1 shown here is a so-called wedge-type VAT valve, which is known per se and in the case of which the valve drive 4 moves the closure member 5 back and forth between the open position and the closed position exclusively in a linear direction, specifically parallel to the valve rod 20. Here, the valve drive 4 may be in the form of a purely linear drive, for example in the form of a hydraulic or pneumatic drive, as shown here, but may also be in the form of an electrical drive or in some other form. Accordingly, it is also possible for other valves, in the form of so-called mono VAT valves, in the case of which the valve drive 4 likewise moves the closure member 5 back and forth between the open position and the closed position exclusively in a linear direction, to be part of an arrangement according to the invention. The hydraulic or pneumatic drives may be so-called piston/cylinder arrangements, which are known per se, but may also be drives with at least one bellows being used. Use may also be made, as also shown below on the basis of other exemplary embodiments, of magnetic leadthroughs or magnetic carriers 32 or bellows leadthroughs, to move the push tube 10 by means of drives which are arranged outside the attachment-part housing 9.

However, arrangements according to the invention may be formed equally well with other valves 1 which are known per se. By way of example, reference may be made in this respect to so-called L-valves, in the case of which the closure member is moved back and forth between the open position and the closed position by one or more valve drives not just in one direction but in two directions, which are at an angle with respect to one another, preferably orthogonal to one another. However, the invention may of course also be realized by so-called swing valves, in the case of which the respective closure member 5 of the valve 1 is not moved linearly but is pivoted about an axis, in order in this way to be moved back and forth between the open position and the closed position. The possibility of arrangements according to the invention being formed in principle with a wide variety of types of valves 1 applies in particular also to modifications of the embodiment variants shown here.

The attachment part 8 and the valve 1 may firstly be manufactured as separate components and then, as shown in FIG. 1, fastened to one another. In the exemplary embodiments shown here, the attachment-part housing 9 has for this purpose a valve-side flange 12 which can be fastened, preferably in a non-destructively detachable manner, to the corresponding valve-housing flange 13 of the valve housing 2 of the valve 1. At the end situated opposite the valve-side flange 12, the attachment-part housing 9 has, in this exemplary embodiment, a line-side flange 14 to which the feed or discharge line 15, shown schematically in FIGS. 2 and 3, can be fastened. Also, the valve housing 2 has a second valve-housing flange 13, which faces away from the attachment part 8 and on which, in turn, a feed or discharge line 15, as indicated in FIGS. 2 and 3, may be arranged. However, by way of said valve-housing flange 13, it is also possible for the valve 1 to be fastened directly to a process chamber or the like.

In FIG. 2, the closure member 5 is in its closed position. The push tube 10 of the attachment part 8, which push tube is mounted displaceably in the attachment-part housing 9, has been retracted from the interior space 3 of the valve housing 2 to such an extent that it does not collide with the closure member 5. For this purpose, the valve drive 4 and the motorized drive device 16 of the attachment part 8 are expediently, for example via a regulating device (not illustrated here), synchronized with one another in such a way that the positions and movements of the closure member 5 and of the push tube 10 can be coordinated with one another in such a way that no collision occurs.

The attachment-part housing 9 and the push tube 10 together form a line cavity 11 of the attachment part 8, by way of which line cavity fluids can be passed through the attachment part 8 and, in the correspondingly extended position of the push tube 10 as per FIG. 3, through the valve housing 2 too.

The attachment-part housing 9 may, as here, be of multi-part form but may also be of one-piece form. Expediently, it comprises, as shown here, both a valve-side flange 12 and a line-side flange 14. The push tube 10 can be pushed through the valve-housing openings 6 and 7 of the valve housing 2 through the valve-side flange 12. For this purpose, the attachment part has a motorized drive device 16 for displacing the push tube 10 relative to the attachment-part housing 9. In the first exemplary embodiment, said motorized drive device 16 is arranged in the attachment part 8 outside the line cavity 11. The motorized drive device 16 of the first exemplary embodiment has an annular cylinder 17 which encircles the push tube 10 in the attachment-part housing 9. In this exemplary embodiment, said cylinder 17 is subdivided into two working chambers by the piston ring 18, which is formed integrally in a fixed manner on the push tube 10 or attached to the latter in some other way. By way of the pressure lines 10, the working chambers of the cylinder 17 can be subjected to pressure, or charged with a pressurizing medium, alternately in order, in this way, for the push tube 10 to be pneumatically or hydraulically displaced relative to the attachment-part housing 9 in a manner known per se. It would of course also be possible for this type of hydraulic or pneumatic drive device realized here to be replaced by other linear drives.

FIG. 3 illustrates the situation in which the closure member 5 is in its open position or maximally open position. In FIG. 3, the push tube 10 of the attachment part 8 has been pushed through the interior space 3 of the valve housing 2. More precisely, in FIG. 3, the push tube 10 of the attachment part 8 has been pushed through the two valve-housing openings 6 and 7 of the valve housing 2. In the end position of the push tube 10 as per FIG. 3, in which said push tube has been pushed through the valve-housing openings 6, 7 of the valve housing 2, the line cavity 11 of the attachment part 8 is sealed off with respect to the rest of the interior space 3 of the valve housing 2. In this way, it is achieved that the fluid approaching in one of the feed or discharge lines 15 is passed through the attachment part 8, and also through the valve housing 2, exclusively by way of the line cavity 11 of the attachment-part housing 9 and of the push tube 10, in order in this way to pass into the oppositely situated feed or discharge line 15. The corresponding arrangement of the push tube 10 in the end position as per FIG. 3 prevents the fluid flowing through from being able to enter the interior space 3 of the valve housing 2 in the region outside the line cavity 11. In this way, even if very dirty fluids are transported, contamination of the interior space 3 of the valve housing 2 and in particular also of the closure member 5, or soiling thereof by dirt deposits, is prevented. For this purpose, the push tube 10, in its end position in which it has been pushed through the valve-housing openings 6 and 7 of the valve housing 2, is respectively sealed off with respect to the valve housing 2 in the region of the valve-housing openings 6 and 7. In the exemplary embodiment shown, this is achieved via corresponding snug fits between the valve housing 2 and the outer surface of the push tube 10. However, if appropriate, it is also possible for provision to be made of corresponding seals or the like in order for the push tube 10 to be sealed off at its outer surface with respect to the valve housing 2.

A description of the second exemplary embodiment as per FIGS. 4 to 8 is given below. Here, however, only the differences from the first exemplary embodiment are discussed. With regard to all the other features and properties of this second exemplary embodiment, reference is made to the statements in relation to the first exemplary embodiment.

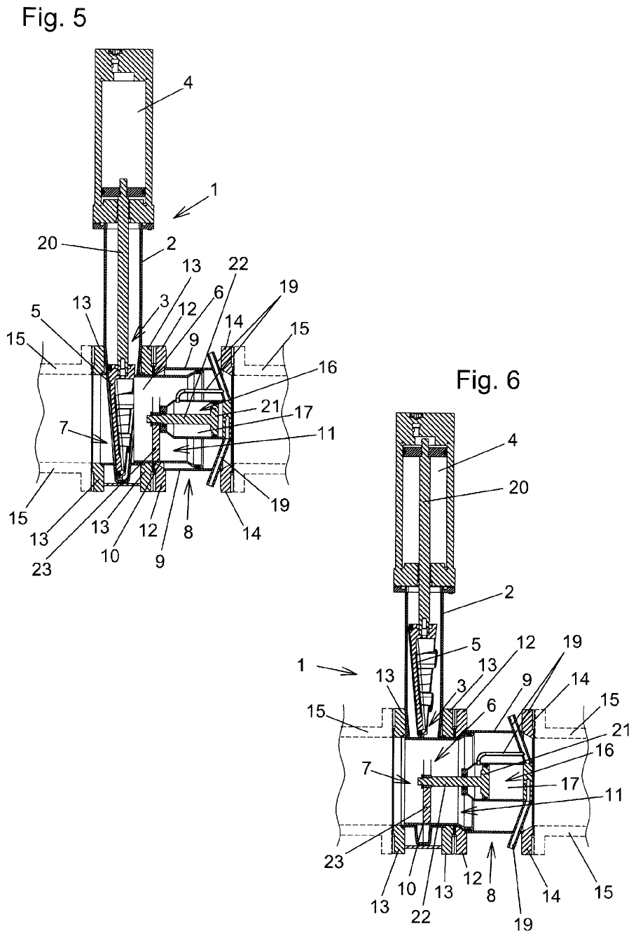

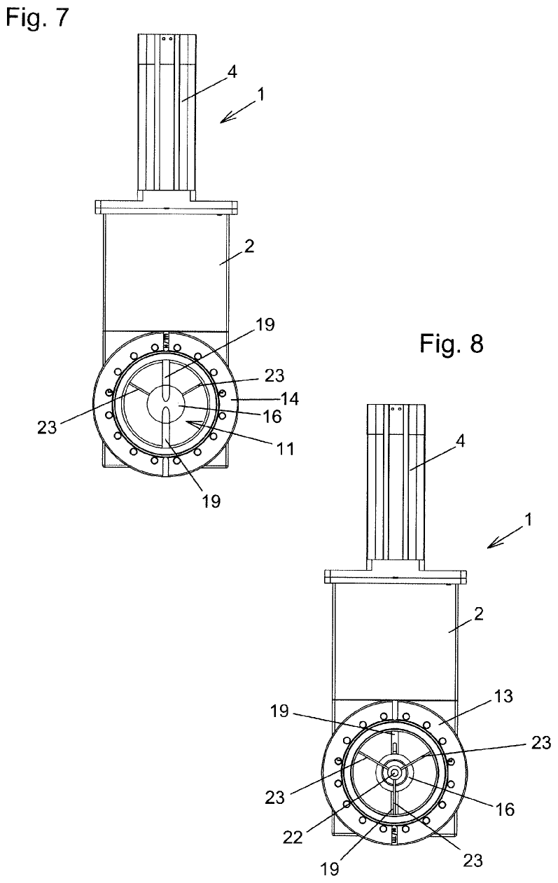

FIG. 4 again shows a perspective illustration of the arrangement according to the invention. FIGS. 5 and 6 each show longitudinal sections, wherein, in FIG. 5, the closure member 5 is in its closed position, and, in FIG. 6, the closure member 5 has been retracted into its maximally open position and the push tube 10 has been pushed through the valve-housing openings 6 and 7 and the interior space 3 of the valve housing 2. Broadly speaking, the expression pushing through also includes the possibility that the push tube 10 has been pushed through one of the valve-housing openings 6, 7 and the interior space 3 and has been pushed into the other valve-housing opening 6, 7 and ends at that region of the valve housing 2 which surrounds the other valve-housing opening 6, 7. FIGS. 7 and 8 also show views of this second exemplary embodiment from the outside.

The difference from the first exemplary embodiment is essentially that, in the second exemplary embodiment, the motorized drive device 16 is arranged in the attachment part 8 within the line cavity 11. This can be seen particularly well in the sectional illustrations as per FIGS. 5 and 6. Again, pneumatically but also hydraulically operable configurations of a motorized drive 16 are involved. The working chambers of the cylinder 17 are again separated from one another by a piston 21 and can be subjected to pressure via the corresponding pressure lines 19. The piston 21 is connected to the push tube 10 via the piston rod 22 and the fastening ribs 23. The housing of the cylinder 17, by contrast, is fixed to the attachment-part housing 9 of the attachment part 8 by means of the pressure lines 19. In this way, the push tube 10 can, through action on the corresponding working chambers in the cylinder 17 of the drive device 16, be moved back and forth relative to the attachment-part housing 9 between the end positions shown in FIGS. 5 and 6. The pressure lines 19 thus have a dual function in this exemplary embodiment. On the one hand, they provide the working chambers in the cylinder 17 with a supply of the corresponding pressure medium. On the other hand, however, they also fasten the housing of the cylinder 17 to the attachment-part housing 9 of the attachment part 8. FIG. 7 shows a view of the attachment part 8 with the line-side flange 14 thereof. The view as per FIG. 8 from the opposite side shows the fastening ribs 23, which fixedly connect the piston rod 22 and thus the piston 21 to the push tube 10.

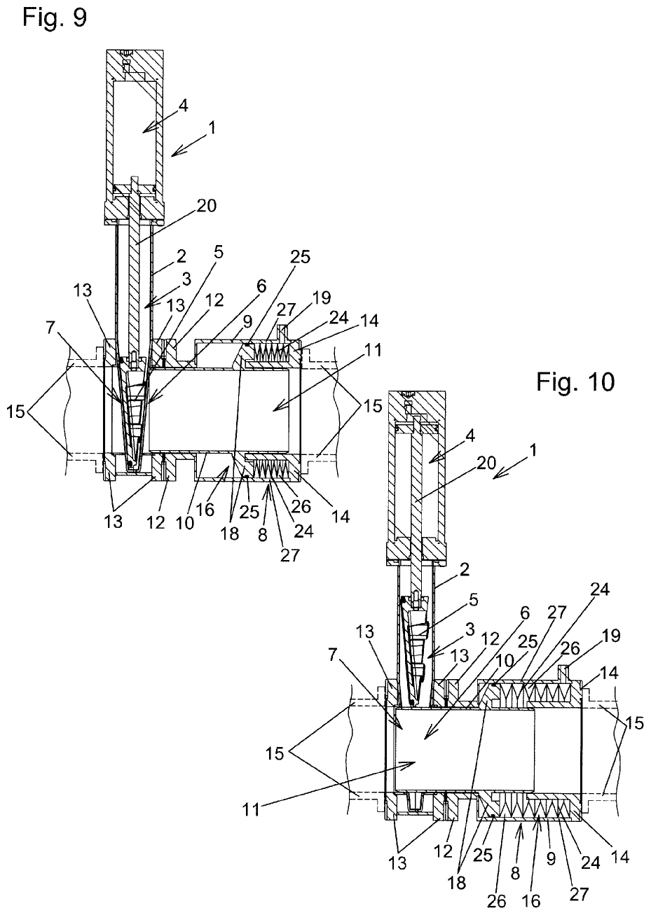

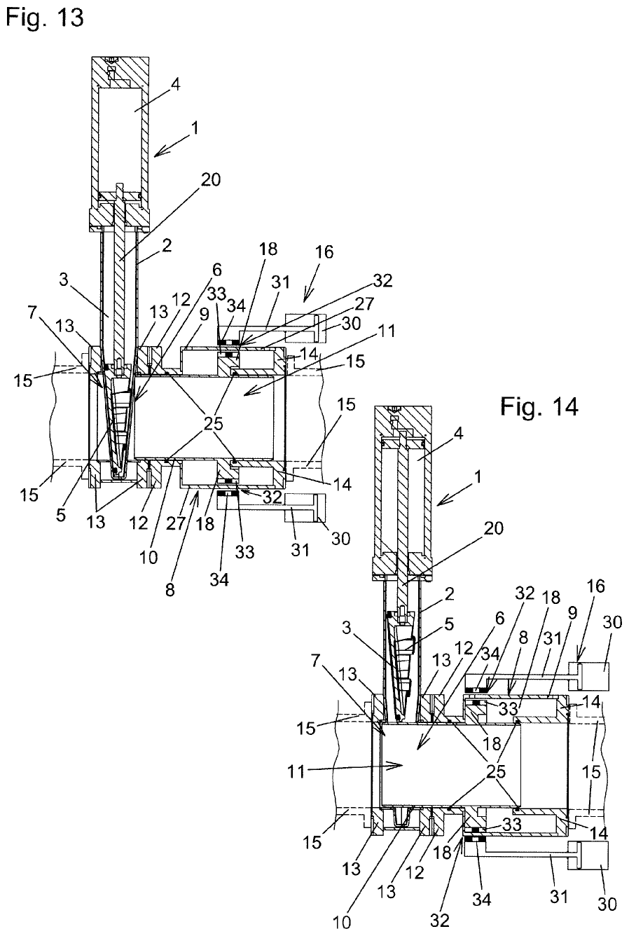

The embodiment variants now described below of arrangements according to the invention are each modifications of the first exemplary embodiment as per FIGS. 1 to 3. A common feature of all of these further variants of the invention is that the respective drive device 16 is arranged outside the line cavity 11. In the exemplary embodiments as per FIGS. 9 to 12, the respective drive device 16 is situated within the attachment-part housing 9 of the respective attachment part 8. In the exemplary embodiments as per FIGS. 13 to 16, the linear drives 30 of the drive devices 16 are even situated outside the attachment-part housing 9.

FIGS. 9, 11, 13 and 15 each show longitudinal sections analogous to FIG. 2, in which the closure member 5 is in the closed position. FIGS. 10, 12, 14 and 16 each show longitudinal sections analogous to FIG. 3, in which the closure member 5 is in the open position or maximally open position and the push tube 10 has been pushed through the valve housing 2 and the two valve-housing openings 6 and 7.

Only the differences from the first exemplary embodiment as per FIGS. 1 to 3 are discussed below. Otherwise, reference is made to the descriptions relating to the first exemplary embodiment.

In the third exemplary embodiment of the invention as per FIGS. 9 and 10, for the purpose of moving the push tube 10 within the attachment-part housing 9, the drive device 16 has an annularly encircling bellows 24 which, together with the outer wall 27, in the form of a cylindrical shell, of the attachment-part housing 9, encloses an annular chamber 26. Via the pressure line 19, said annular chamber 26 can be subjected to pressure, through introduction of a correspondingly liquid or gaseous pressure medium, such that the piston ring 18, with the push tube 10 fastened thereto, can be displaced from the retracted position shown in FIG. 9 into the end position shown in FIG. 10. The seal 25 seals off the piston ring 18 with respect to the outer wall 27. The return movement, proceeding from FIG. 10, to the situation as per FIG. 9 may be realized in that the pressure medium is discharged from the annular chamber 26 via the pressure line 19 and the bellows 24, owing to its elastic preload, contracts into the state as per FIG. 9 again and in the process carries along the piston ring 18 and thus the push tube 10. As an alternative or in addition to this elastic return movement owing to the bellows 24 itself, it may of course also be provided that the pressure medium is actively extracted by suction from the annular chamber 26 via the pressure line 19. In this way, too, the push tube 10, proceeding from the position as per FIG. 10, can be pushed back into the position as per FIG. 9 again.

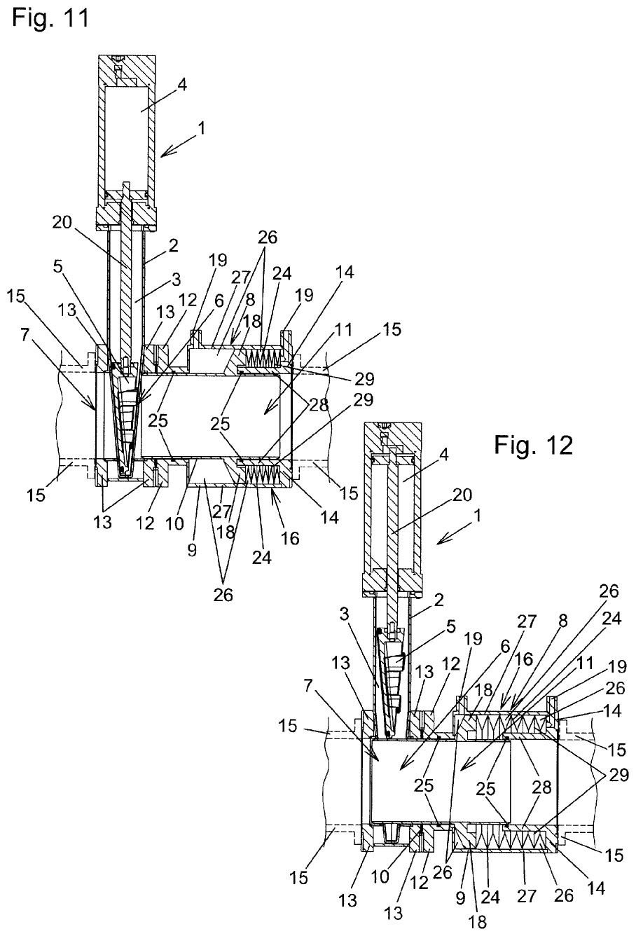

A bellows solution for forming the drive device 16 within the attachment-part housing 9 is also provided in the fourth exemplary embodiment according to the invention as per FIGS. 11 and 12. In this exemplary embodiment as per FIGS. 11 and 12, the bellows 24 delimits two annular chambers 26 and 29 from one another within the attachment-part housing 9. The annular chamber 26 is again formed between the outer wall 27 of the attachment-part housing 9 at one side and the bellows 24 at the other side. By contrast, the annular chamber 29 is delimited by the bellows 24 at one side but at the other side by the inner wall 28 or the push tube 10. If it is desired to bring the push tube 10 from the position as per FIG. 11 into the position as per FIG. 12, then the annular chamber 29 is acted on by means of the pressure line 19 facing toward the line-side flange 14. For the return movement, proceeding from FIG. 12, into the position as per FIG. 11, the annular chamber 26 is acted on via the pressure line 19 on the side of the valve-side flange 12.

In the fifth exemplary embodiment as per FIGS. 13 and 14, the linear drives 30 of the drive device 16 are arranged outside the attachment-part housing 9. Any linear drives 30 which are known per se in the prior art may be involved. In FIGS. 13 and 14, the linear drives 30 are illustrated as piston/cylinder arrangements for the purpose of simplicity. These may be operated both pneumatically and hydraulically. However, as said, different linear drives 30 which are known per se may also be involved. In this fifth exemplary embodiment as per FIGS. 13 and 14, the transmission of the movement of the connecting rods 31 by means of the linear drives 30 to the push tube 10 is realized by so-called magnetic carriers 32. Said magnetic carriers 32 are formed by in each case two magnet arrangements 33 and 34 which interact with one another in a pairwise manner. The magnet arrangements 34 are situated, in each case in the respective connecting rod 31, outside the outer wall 27 and thus outside the attachment-part housing 9. The magnet arrangements 33 interacting therewith are in each case arranged in the piston ring 18 and thus within the outer wall 27 of the attachment-part housing 9. The magnet arrangements 33 are connected fixedly to the push tube 10 via the piston ring 18. The magnet arrangements 33 and 34 preferably in each case have a sequence of permanent magnets which are arranged adjacently to one another and which are in each case of alternating polarity. The magnet arrangements 33 and 34 are arranged relative to one another in such a way that in each case two magnets situated directly opposite one another attract one another through the outer wall 27. Through this type of magnetic coupling, the piston ring 18, and thus the push tube 10, follows the movement of the connecting rods 31 by means of the linear drives 30, so that the push tube 10 can be moved back and forth between the positions as per FIGS. 13 and 14 through corresponding actuation of the linear drives 30.

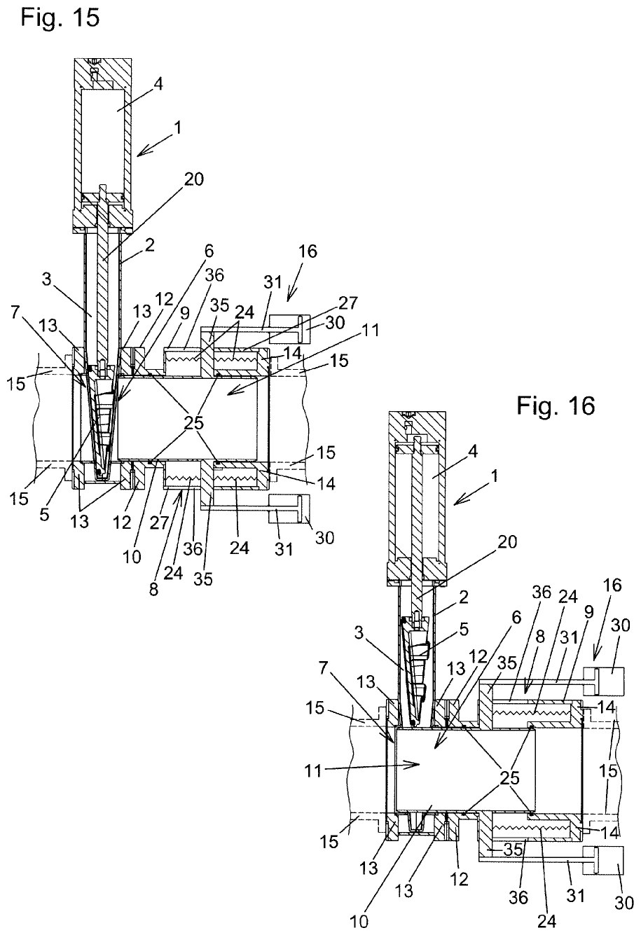

In the sixth exemplary embodiment as per FIGS. 15 and 16, by contrast, the connecting rods 31 of the linear drives 30 are connected fixedly to the push tube 10 in a mechanical manner by means of carrier webs 35. In this exemplary embodiment, the carrier webs 35 are led through an annularly formed bellows 24 and corresponding longitudinal slots 36 in the outer wall 27. In this case, the bellows 24 provides for corresponding sealing of the interior space of the attachment-part housing 9 to the outside. Via this type of bellows leadthrough, the linear drives 30 can, via the connecting rods 31 and the carrier webs 35, again push the push tube 10 back and forth between the positions as per FIGS. 15 and 16. As in the above-described exemplary embodiments, the seals 25 seal off the push tube 10, at the outer surface thereof, with respect to the attachment-part housing 9.

Legend for the Reference Signs:

| | |
|---|---|
| 1 | Valve |
| 2 | Valve housing |
| 3 | Interior space |
| 4 | Valve drive |
| 5 | Closure member |
| 6 | Valve-housing opening |
| 7 | Valve-housing opening |
| 8 | Attachment part |
| 9 | Attachment-part housing |
| 10 | Push tube |
| 11 | Line cavity |
| 12 | Valve-side flange |
| 13 | Valve-housing flange |
| 14 | Line-side flange |
| 15 | Feed or discharge line |
| 16 | Drive device |
| 17 | Cylinder |
| 18 | Piston ring |
| 19 | Pressure line |
| 20 | Valve rod |
| 21 | Piston |
| 22 | Piston rod |
| 23 | Fastening rib |
| 24 | Bellows |
| 25 | Seal |
| 26 | Annular chamber |
| 27 | Outer wall |
| 28 | Inner wall |
| 29 | Annular chamber |
| 30 | Linear drive |
| 31 | Connecting rod |
| 32 | Magnetic carrier |
| 33 | Magnet arrangement |
| 34 | Magnet arrangement |
| 35 | Carrier web |
| 36 | Longitudinal slot |

1. An arrangement, comprising:
a valve having a valve housing and a closure member said closure member being mounted for movement back and forth in an interior space of the valve housing between a closed position and an open position by a valve drive, and two mutually aligned valve-housing openings arranged in the valve housing, wherein the closure member closes off the valve-housing openings in the closed position and opens up the valve-housing openings in the open position;
an attachment part having an attachment-part housing and a push tube, the push tube is mounted displaceably in the attachment-part housing, the attachment-part housing and the push tube together enclose a line cavity of the attachment part configured for passing of a fluid through the attachment part; and
the attachment-part housing is fastened to an outside of the valve housing, and the push tube is pushable through the interior space of the valve housing when the closure member is in the open position.

2. The arrangement as claimed in claim 1, wherein, in an end position of the push tube in which the push tube has been pushed through the valve-housing openings of the valve housing, the line cavity of the attachment part is sealed off with respect to the interior space of the valve housing.

3. The arrangement as claimed in claim 1, wherein, in an end position of the push tube in which the push tube has been pushed through the valve-housing openings of the valve housing, the push tube is respectively sealed off with respect to the valve housing in a region of the valve-housing openings.

4. The arrangement as claimed in claim 1, wherein, in an end position of the push tube in which the push tube has been pushed through the interior space of the valve housing, the push tube projects beyond the attachment-part housing.

5. The arrangement as claimed in claim 1, wherein the attachment-part housing has a valve-side flange for, fitting of the attachment part to the valve, and the push tube is pushable through the valve-housing openings of the valve housing through the valve-side flange.

6. The arrangement as claimed in claim 1, wherein the attachment-part housing has a line-side flange configured for fitting of the attachment part to a feed or discharge line or to another component.

7. The arrangement as claimed in claim 1, wherein the attachment part has at least one motorized drive device configured for displacing the push tube relative to the attachment-part housing.

8. The arrangement as claimed in claim 7, wherein the motorized drive device is arranged in the attachment part outside the line cavity.

9. The arrangement as claimed in claim 7, wherein the motorized drive device is arranged in the attachment part within the line cavity.

10. The arrangement as claimed in claim 7, wherein the motorized drive device for displacing the push tube relative to the attachment-part housing and the valve drive are synchronized with one another.

11. The arrangement as claimed in claim 5, wherein the attachment-part housing valve-side flange is fitted to a valve-housing flange of the valve housing.
